(19) United States
(12) Patent Application Publication
(10) Pub. No.: US 2021/0352851 A1
(43) Pub. Date: Nov. 18, 2021

(54) Planter Saucer with Support for Stakes

(71) Applicant: Kelley Shire Tree Trust, Fairfax, VA (US)

(72) Inventor: James Kelley, JR., Fairfax, VA (US)

(21) Appl. No.: 17/319,884

(22) Filed: May 13, 2021

Related U.S. Application Data
(60) Provisional application No. 63/024,920, filed on May 14, 2020.

(51) Int. Cl. A01G 9/04; A01G 9/12

(52) U.S. Cl. CPC A01G 9/042; A01G 9/124

(57) ABSTRACT

A saucer for a planter includes a flat upper saucer surface configured to receive a planter. The planter has a bottom planter surface with at least one drain hole. The saucer also includes at least one support rigidly attached to the upper saucer surface at a location corresponding to the at least one drain hole when the planter is placed on the saucer. An outer diameter of the support is smaller than an inner diameter of the drain hole. A hole in an upper surface of the support has a size configured to snugly fit a lower end of a shaft of a stake. A depth of the hole within the support is sufficient to keep the stake inserted therein erect upon loading of the stake with a weight of a plant disposed in the planter.

### BACKGROUND

Planters are pots that are used for growing live plants, either indoors or outdoors, by holding soil to support a plant's roots and supply nutrients for the plant growing therein. The planters come in a variety of sizes to support both small and large plants. Many planters have one or more holes in the bottom of the pot to allow excess water to drain out of the soil upon watering the plant growing therein. Such holes are called drain holes, herein. Often a saucer is placed beneath the planter to catch the excess water and to hold the excess water for evaporation, or for later absorption by the soil inside the planter and for eventual use by the plant growing therein.

### SUMMARY

The inventor has recognized that a problem with current planter and saucer systems arises when a plant grows beyond the plant's ability to support its own weight, and a stake is needed to support the plant. This occurs, for example, during growth of some fruit bearing plants, such as tomato plants. While a stake can be inserted into the soil inside the planter, and the plant tied to the stake for support, the soil is often not sufficiently rigid to keep the stake itself from tipping over under the weight of the growing plant. Therefore, in various embodiments, a saucer is provided that can rigidly support the stake.

According to a first set of embodiments, a saucer for a planter includes a flat upper saucer surface configured to receive a planter. The planter has a bottom planter surface with at least one drain hole. The saucer also includes at least one support rigidly attached to the upper saucer surface at a location corresponding to the at least one drain hole when the planter is placed on the saucer. An outer diameter of the support is smaller than an inner diameter of the drain hole. A hole in an upper surface of the support has a size configured to snugly fit a lower end of a shaft of a stake. A depth of the hole within the support is sufficient to keep the stake inserted therein erect upon loading of the stake with a weight of an object disposed in the planter.

In some embodiments of the first set, the at least one drain hole includes a plurality of drain holes and the at least one support includes a plurality of support.

In some embodiments of the first set, the support is an annulus with a circular outer perimeter, and the hole is a concentric circular inner surface of the annulus.

In other sets of embodiments, a system includes the above saucer with the planter, or with the stake, or both.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is an exploded perspective view of a planter with saucer having at least one stake support rigidly fixed to a center of an inside surface of the saucer and configured to receive a stake disposed inside the planter and into the interior of the stake support that is configured to protrude through a center drainage hole in the pot, according to an embodiment;

FIG. 1B is an assembled perspective view of the planter with saucer having at least one stake support rigidly fixed to the center of the inside surface of the saucer and configured to receive the stake disposed inside the planter and into the hole of the stake support that is configured to protrude through the center drainage hole in the planter, according to an embodiment;

FIG. 2 is an exploded perspective view of the planter with a different saucer having at least one stake support rigidly fixed, off-center, to an inside surface of the saucer and configured to receive a stake disposed inside the planter and into the hole of the stake support that is configured to protrude through an off-center drainage hole in the planter, according to an embodiment;

FIG. 3 is an exploded perspective view of a planter with a different saucer having multiple stake supports rigidly fixed to an inside surface of the saucer, each stake support configured to receive a stake disposed inside the planter and into the hole of the stake support that is configured to protrude through a drainage hole in the planter, according to an embodiment;

FIG. 4A through FIG. 4F are plan views of different stake supports, according to various embodiments; and

FIG. 5A through FIG. 5D are photographs that illustrate an example embodiment of saucer and stake and pot, according to an embodiment.

### DETAILED DESCRIPTION

A saucer with stake supports for a planter is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader rang around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of large outdoor planters and saucers for growing plants too heavy to be supported by their own stems. However, the invention is not limited to this context. In other embodiments larger or smaller planters and saucers for various-sized objects such as living or artificial plants, or decorations such as sculptures or mobiles, utilize the saucers with stake support members described herein.

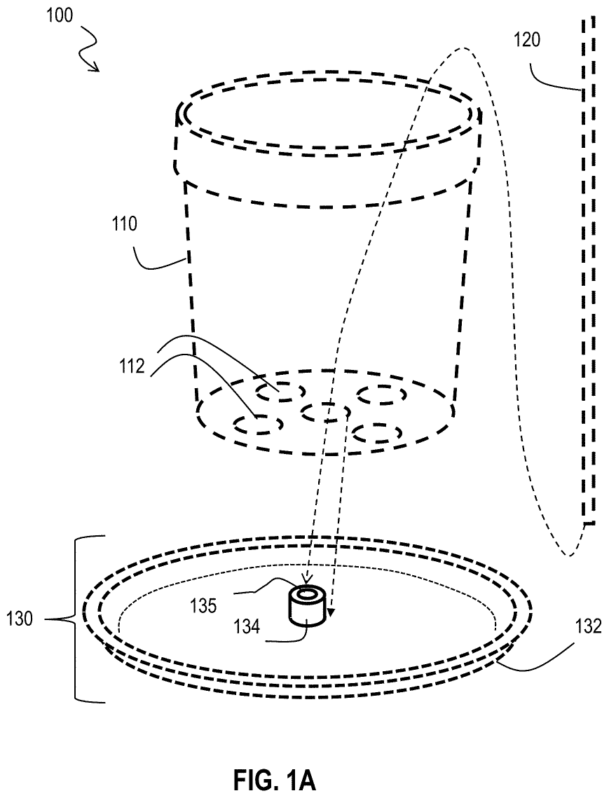

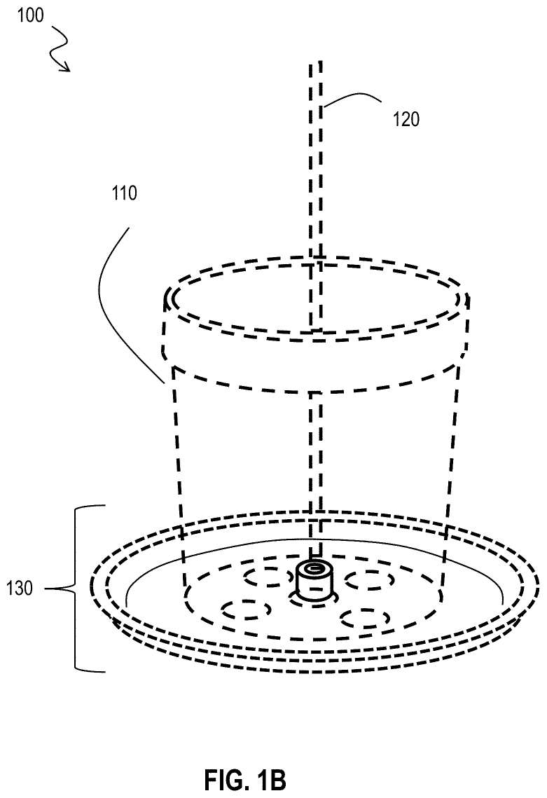

FIG. 1A is an exploded perspective view of a planter 110 with saucer 130 having at least one stake support 134 rigidly fixed to a center of an inside surface of a basic saucer 132 and configured to receive a stake 120 disposed inside the planter 110 and into a hole 135 in the stake support 134 that is configured to protrude through a center drainage hole 112 in the planter 110, according to an embodiment. A system 100 includes the planter 110, stake 120 and saucer 130.

Any planter may be used. The planter may be made of any material, including ceramic, metal, plastic, plaster, and wood, alone or in some combination. The size of the planter may be any in use, from a few centimeters in diameter and height to one or more meters in either diameter or height or both. Though diameter is defined with reference to circular shapes, as used herein, a diameter refers to the smallest circumscribed circle that encloses a cross section of any three-dimensional shape in an appropriate plane. Though the planter 110 has a truncated conical planter 110 as depicted, any shaped planter may be used in various embodiments, including circular cylindrical, hemispherical or spherical, parabolic, regular or irregular polygonal cylinders, full cones, or any other straight- or curved-segmented shapes, vertically straight or tapered. Although the planter 110 is depicted with five circular drain holes 112, other planters may have more or fewer drain holes in the same or different positions with the same or different shapes. For example, a center drain hole 112 may be missing, in some embodiments. The size of the drain holes may vary in various embodiments, e.g., from a few millimeters to several or tens of centimeters in diameter.

Although one annulus-shaped stake support 134 is depicted in saucer 130, in other embodiments, depicted in more detail below, other stake supports with the same or different shapes and the same or different shaped holes at the same or different locations on basic saucer 132 may be used. The stake support 134 is rigidly attached to the basic saucer 132 and may be integrally fabricated with the basic saucer 132 (e.g., with a 3-D printer, injection molding, open molding, pre-firing sculpting, among others), or may be formed of the same or different material and rigidly fixed to the basic saucer 132, e.g., with glue, epoxy, rivets screws or other fastener. The stake support 134 may be made of any material, including ceramic, metal, plastic, plaster, and wood, alone or in some combination.

The outer diameter of the stake support 134 is advantageously smaller than the diameter of the drain hole 112 of the planter with which the saucer will be used, and the location of the stake support 134 on the basic saucer 132 is advantageously aligned with a location of at least one drain hole 112 in the planter 110 when the planter 110 is placed on the saucer 130, so that the stake support 134 can pass through the drain hole 112 and the stake support 134 can be accessed from an inside of the planter 110. Example outer diameters of the stake support 134 are 1 to 10 centimeters, or 1 to 2.5 centimeters.

The stake 120 may be any stake in use, including painted or unpainted wood dowels, painted or unpainted metal rods, plastic rods for gardening or for mobile sculptures or for other uses. It is only required that the at least one end be smaller in diameter than the drain hole 112 of the planter 110 and smaller than an outer diameter of the stake support. It is advantageous for the diameter of hole 135 in the stake support 134 to match the diameter of the end of the stake 120 so that the end of the stake 120 fits snugly into the hole 135. The hole 135 should be deep enough in the stake support 134, and thus the stake support 134 should be tall enough above basic saucer 132, so that when the end of the stake 120 is fit into the hole 135, the stake 120 is able to withstand tipping by the application of a transverse force onto the stake 120, such as a force imposed by a plant too heavy for its own stalk. The stake advantageously extends above the upper rim of the planter 110 by a distance on the same order (e.g., 0.1 to ten times) as the height of the planter 110, e.g., several centimeters to several meters, and preferably at least about one foot (about 30 cm). The holder advantageously prevents the stake falling over or out under lateral forces from about 5 newtons to about 40 newtons, or from 10 newtons to about 30 newtons, or for example from 12 newtons to about 30 newtons.

FIG. 1B is an assembled perspective view of the planter 110 with saucer 130 having at least one stake support rigidly fixed to the center of the inside surface of the saucer and configured to receive the stake 120 disposed inside the planter and into the hole of the stake support that is configured to protrude through the center drainage hole in the planter, according to an embodiment. System 100 comprises planter 110, saucer 130 and stake 120.

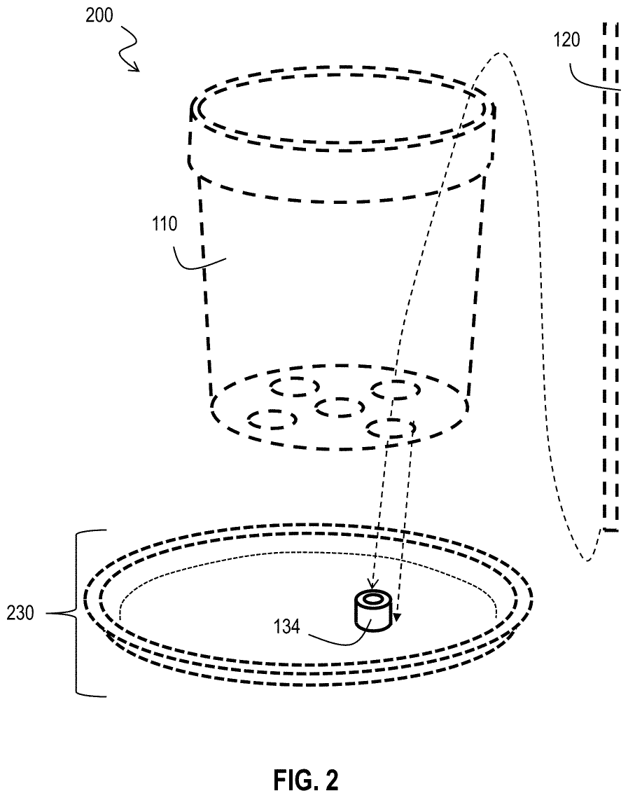

FIG. 2 is an exploded perspective view of the planter 110 with a different saucer 230 having at least one stake support 134 rigidly fixed, off-center, to an inside surface of the basic saucer and configured to receive a stake 120 disposed inside the planter 110 and into the hole of the stake support 134 that is configured to protrude through an off-center drainage hole in the planter, according to an embodiment. System 200 comprises planter 110, saucer 230 and stake 120.

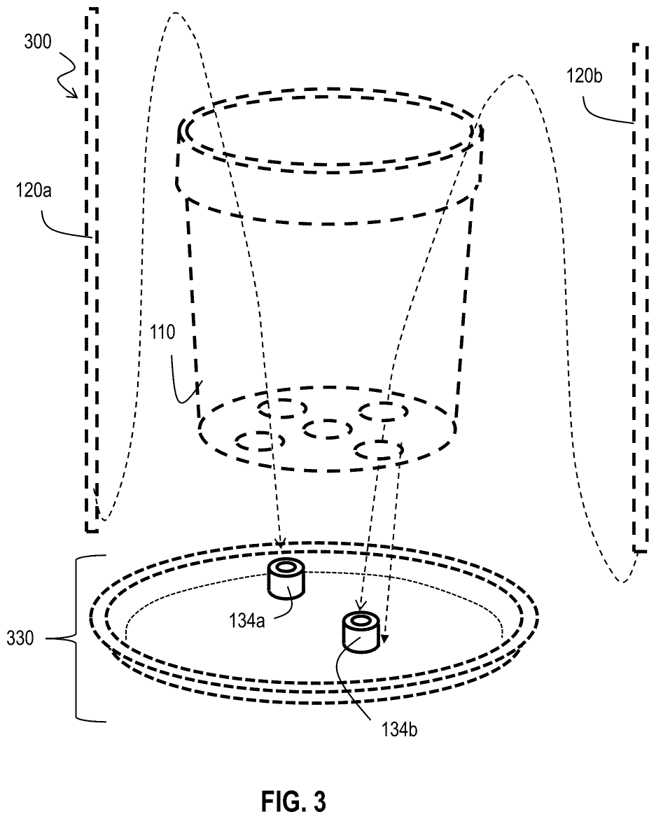

FIG. 3 is an exploded perspective view of a planter 110 with a different saucer 330 having multiple stake supports (134a and 134b, collectively referenced as stake support 134) rigidly fixed to an inside surface of the basic saucer, each stake support 134 configured to receive a stake 120a and 120b, respectively, collectively referenced as stakes 120) disposed inside the planter 110 and into the hole of the stake support 134 that is configured to protrude through a drainage hole in the planter, according to an embodiment. System 300 comprises planter 110, saucer 330 and stakes 120a and 120b.

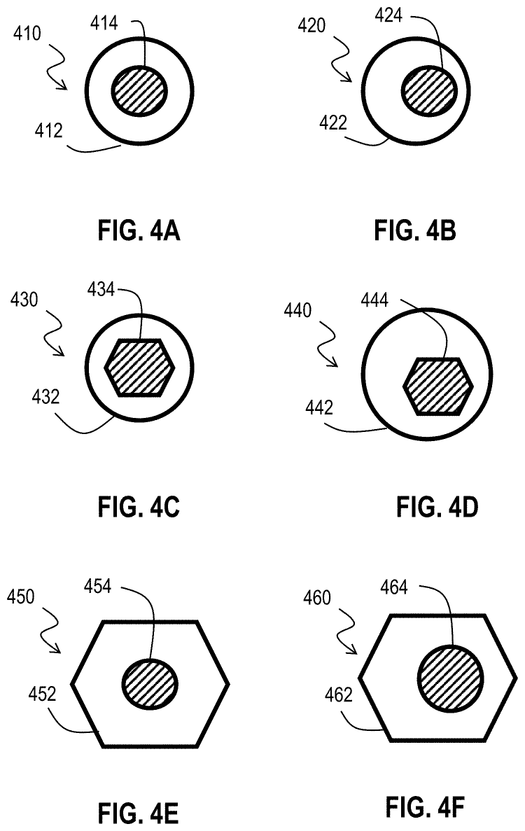

As stated above, the stake support 134 can have any outer shape and centered or off-centered hole shape. Example shapes are depicted in FIG. 4A through FIG. 4F. FIG. 4A through FIG. 4F are plan views of different stake supports, according to various embodiments. While a hexagon is used in FIG. 4A through FIG. 4F, as an example non-circular shape, any regular or irregular polygon or segmented concave or convex arcs may be used as a non-circular shape in various embodiments. Some shapes have an advantage in providing a range of inner diameters that can more tightly grab a stake that has an irregular, or not-precisely-known, cross-sectional shape or size.

FIG. 4A is a plan view of a stake support 410 shaped as an annulus, which has a circular outer edge 412 and concentric circular inner edge 414, the latter circumscribing the hole 135. FIG. 4B is a plan view of a stake support 420 which has a circular outer edge 422 and off-center circular inner edge 424, the latter circumscribing the hole 135. FIG. 4C is a plan view of a stake support 430 which has a circular outer edge 432 and concentric hexagon inner edge 434, the latter circumscribing the hole 135. FIG. 4D is a plan view of a stake support 440 which has a circular outer edge 442 and an off-center hexagon inner edge 444, the latter circumscribing the hole 135. FIG. 4E is a plan view of a stake support 450 which has a hexagon outer edge 452 and concentric circular inner edge 454, the latter circumscribing the hole 135. FIG. 4F is a plan view of a stake support 460 which has a hexagon outer edge 462 and an off-center circular inner edge 464, the latter circumscribing the hole 135. In other embodiments, other combinations of outer and inner shaped edges, either centered and off-centered, are used for the stake support

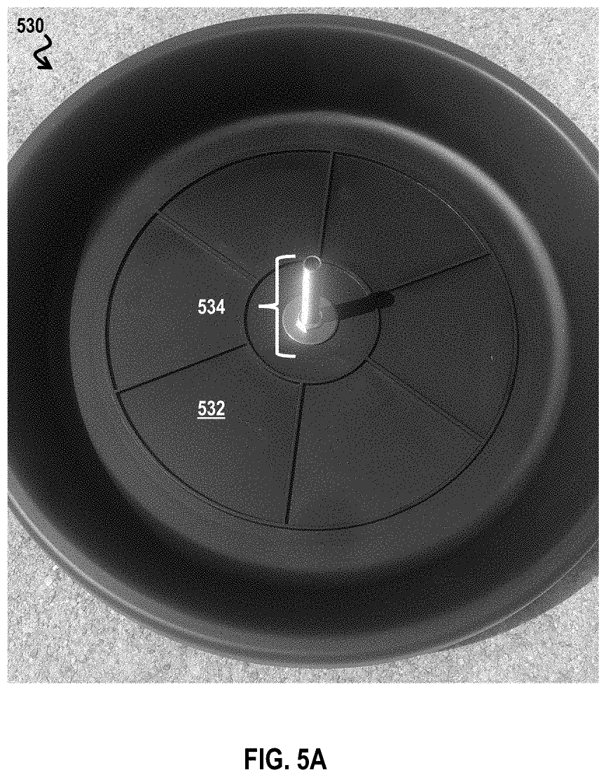

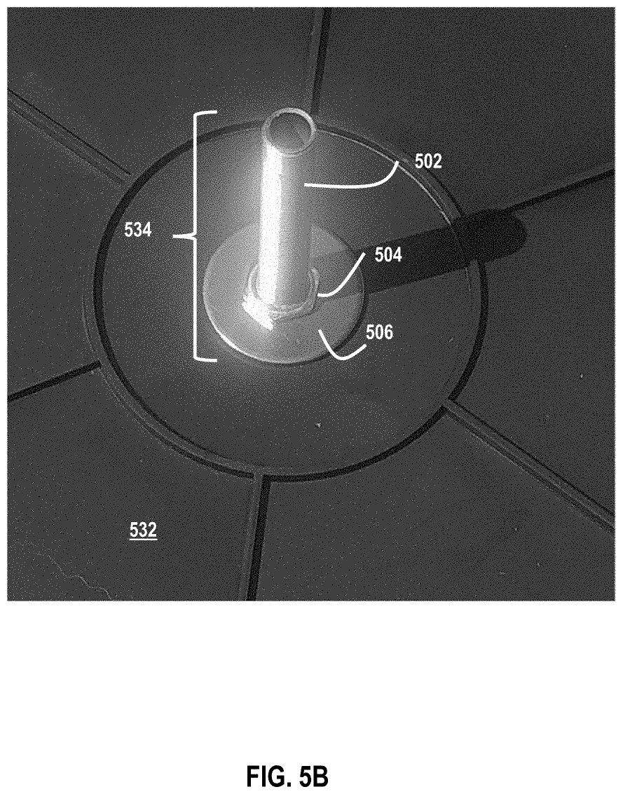

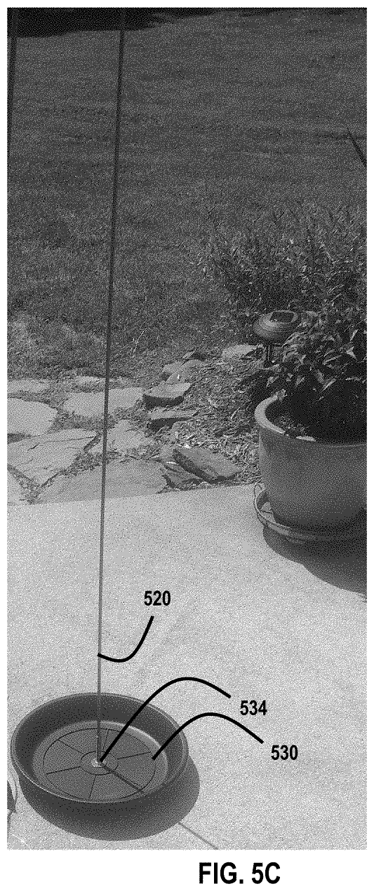

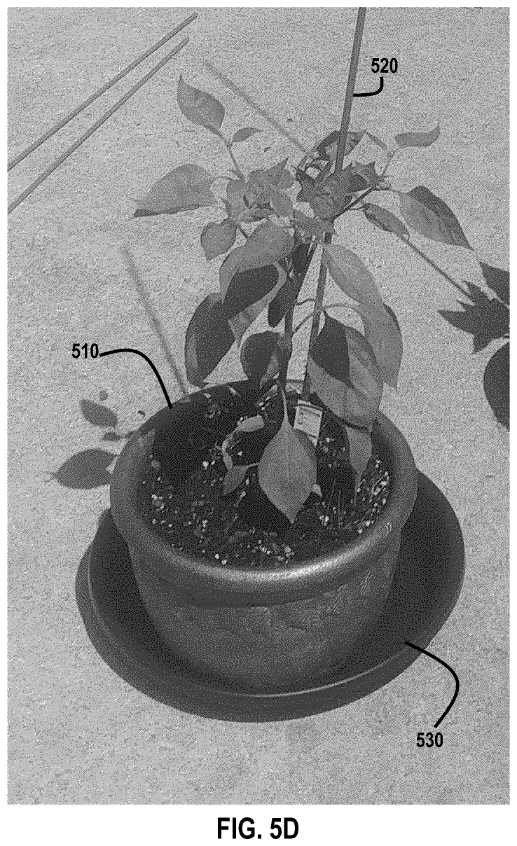

Experiential embodiments were constructed and used, as described here. In a first experimental embodiment, the basic saucer is made of plastic and has a diameter of about 20 inches (about 50 cm). An annular stake support made of threaded galvanized steel pipe had an outer diameter of about ⅞ inch (2.2 cm) and an inner diameter of about 6/8 inch (1.9 cm) circumscribing the hole. The annulus is about 1.5 inches (4 cm) high and the hole is also about 1.5 inches deep, traversing through the basic saucer. The annulus is attached to the basic saucer at a center location and is rigidly attached to the saucer using nuts and washers. This embodiment is depicted in photographs in FIG. 5A through FIG. 5D.

FIG. 5A through FIG. 5D are photographs that illustrate an example embodiment of saucer, stake and pot, according to an embodiment. FIG. 5A illustrates a saucer 530 with annular stake support 534 affixed to basic saucer 532. FIG. 5B illustrates details of annular stake support 534 on basic saucer 532. The annular stake support 534 includes a threaded pipe 502 affixed to the basic saucer 532 with at least one nut 504 on a top side of basic saucer 532, and another nut, not shown, on the bottom side. An optional washer 506 is included on the top side to take the pressure exerted by tightening the nut 504 and spread that force to the surface of the washer to avoid damaging the basic saucer 532. In some embodiments, another washer, not shown, is included on the bottom side of basic saucer 532 and above the other nut, not shown. FIG. 5C shows the saucer 530 with a ⅝ inch diameter stake 520 that is about 2 meters (over 6 feet) tall inserted into the stake holder 534. FIG. 5D shows the saucer 530 with stake 520 passing upward through a pot 510. Soil and plant in the pot 510 are not part of saucer, stake, pot system; however, it is clear that the plant can be supported by the stake 520 that is supported by the saucer 530.

An advantage of the saucer with stake support is that the stake positioned within the state support can withstand a greater lateral force; and thus hold upright a larger object, e.g., a plant laden with fruit such as tomatoes. In an experimental embodiment, a 20 inch (50 cm) planter pot was filled with about 16 inches (40 cm) of potting soil. In a control experiment, a ⅝ inch (1.6 cm) metal tomato stake was inserted in soil only (not into the stake holder) to the bottom of the pot. A luggage scale was attached halfway up the stake. A lateral force of 2.8 pounds (lbs, 2.8 lbs is about 12.5 newtons) pulled the stake over to the top edge of the pot. In an embodiment of the invention, a ⅝ inch tomato stake was inserted into the stake holder, then up through a drainage hole of the same planter. A lateral force of 6.9 lbs (30.7 newtons) pulled the stake only to a 45° angle. At greater force, the stake itself would bend.

In various other embodiments, commercial stakes are used, such as ⅝ inch diameter stakes or ⅜ inch diameter stakes or ¼ inch diameter stakes, each with a height of about 4 feet, or about 5 feet or about 6 feet, and each used with a stake holder having a hole with a matching inner diameter of about ⅝ inch or about ⅜ inch or about ¼ inch, respectively. In various embodiments, small planter pots (less than or equal to about 6 inches in diameter), medium planter pots (from about 6 inches in diameter to about 20 inches in diameter), or large planter pots (greater than or equal to about 20 inches in diameter) are used. In various embodiments, small planter pots have drain holes in a range from about ½ inch to about ¾ inch; medium planter pots have drain holes of about one inch in diameter; and, large planter pots have drain holes about 1.5 inches or more in diameter. Thus, in some embodiments, stake holders have an outer diameter of about one half inch to fit inside the drain holes of the small pots and each with a hole having a smaller inner diameter of about ¼ inch or ⅜ inch to accommodate various commercially available stakes. In other embodiments, the stake holders have an outer diameter of just under one inch to fit inside the drain holes of medium and large pots, each with a hole having a smaller inner diameter of about ⅝ inch or about ⅜ inch to accommodate various commercially available stakes.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A saucer for a planter, the saucer comprising:
a flat upper saucer surface configured to receive a planter, wherein the planter has a bottom planter surface with at least one drain hole therein; and
at least one support rigidly attached to the upper saucer surface at a location corresponding to the at least one drain hole when the planter is placed on the saucer, wherein
an outer diameter of the support is smaller than an inner diameter of the drain hole,
a hole in an upper surface of the support has a size configured to snugly fit a lower end of a shaft of a stake, and
a depth of the hole within the support is sufficient to keep the stake inserted therein erect upon loading of the stake with a weight of an object disposed in the planter.

2. A saucer as recited in claim 1, wherein the at least one drain hole includes a plurality of drain holes and the at least one support includes a plurality of supports at locations on the saucer surface that correspond to the plurality of drain holes when the planter is placed on the saucer.

3. A saucer as recited in claim 1, wherein the support is an annulus with a circular outer perimeter and the hole is a concentric circular inner surface of the annulus.

4. A system comprising the saucer as recited in claim 1 and the planter.

5. The system as recited in claim 3, further comprising the stake, wherein the stake is long enough to extend from the annulus through the planter and above the planter by at least one foot.
